(19) United States
(12) Patent Application Publication
(10) Pub. No.: US 2006/0013330 A1
(43) Pub. Date: Jan. 19, 2006

(54) MIMO transmission system and method of OFDM-based wireless LAN systems

(76) Inventor: Kil-sik Ha, Anyang-si (KR)

Correspondence Address: STANZIONE & KIM, LLP, 919 18TH STREET, N.W., SUITE 440, WASHINGTON, DC, 20006, US

(21) Appl. No.: 11/181,740

(22) Filed: Jul. 15, 2005

(30) Foreign Application Priority Data
Jul. 16, 2004 (KR) 2004-55623

(51) Int. Cl. H04B 7/02

(52) U.S. Cl. 375/267

(57) ABSTRACT

A MIMO transmission system and method of an OFDM-based wireless LAN system. The MIMO transmission system includes multiple transmission paths to channel antennas and receives and encodes plural rows of bit streams. The MIMO transmission system does not transmit the plural rows of bit streams through the same paths and channel antennas, but sequentially switches, OFDM-modulates, and sends bits of each bit stream to the plural paths such that the bit streams are not transmitted through the same paths and channel antennas. Through the bit exchange among the channel antennas, the MIMO transmission system can enhance diversity gains by the channel encoding in flat-fading environments having a small RMS delay spread.

### CROSS-REFERENCE TO RELATED APPLICATIONS

This application claims benefit under 35 U.S.C. § 119 from Korean Patent Application No. 2004-55623, filed on Jul. 16, 2004, the entire content of which is incorporated herein by reference.

### BACKGROUND OF THE INVENTION

1. Field of the Invention

The present general inventive concept relates to a wireless local area network (WLAN) system, and more particularly, to a multiple input multiple output (MIMO) transmission system and method of an orthogonal frequency division multiplexing (OFDM)-based wireless LAN system to enhance a diversity effect of the MIMO transmission system of the OFDM-based wireless LAN system under flat-fading environments.

2. Description of the Related Art

The existing standard IEEE 802.11 for a wireless LAN has supported a transmission rate of 2 Mbps in industrial, scientific medical (ISM) bands of 2.4 GHz using Direct Sequence Spread Spectrum (DSSS), Frequency Hopping Spread Spectrum (FHSS), or Infrared (IR) technique. However, the standard IEEE 802.11 can not satisfy increasing demands of high transmission rates, so substandards IEEE 802.11a and IEEE 802.11b for new physical layers were established.

The substandard IEEE 802.11a has chosen an orthogonal frequency division multiplexing (OFDM) transmission system using an OFDM modulation method in order to overcome the limitation of the DSSS system in a 5 GHz unlicensed band of Unlicensed National Information Infrastructure (U-NII) and obtain a higher transmission rate. Error corrections are carried out by convolution encoders having encoding rates of ½, ⅔, and ¾ and a ½ Viterbi decoder, and sub-carrier modulations are carried out through Binary Phase Shift Keying (BPSK), Quadrature Phase Shift Keying (QPSK), Quadrature Amplitude modulation (QAM), or 64-QAM scheme.

Thus, the substandard IEEE 802.11a supports a high-speed variable transmission rate from 6 Mbps to 54 Mbps by combining encoders and modulators depending on channel states. Further, the substandard IEEE 802. 11a has an advantage of a simple structure of 52 sub-carriers, a short training period of time and a simple equalization by use of the OFDM transmission system, and robustness to interferences among multiple paths, since its goal is Ethernet-based services in room environments.

Further, the existing wireless communication systems are for high-quality and large-volume multimedia data transmissions over limited frequencies, and increase a transmission data rate with a MIMO transmission system using plural antennas in order to send a large volume of data over the limited frequencies.

An inter symbol interference (ISI) and a frequency selectively fading in the MIMO transmission system can be almost completely removed when the OFDM-based system is used together with the MIMO transmission system.

A conventional MIMO OFDM-based wireless LAN transmission system converts a signal encoded through convolutional encoders, puncturers, and interleavers into a modulation signal of BPSK, QPSK, QAM, and so on, according to a symbol mapper, and inserts guard intervals during modulations by applying an inverse fast Fourier transform. IN addition, the conventional MIMO OFDM-based wireless LAN transmission system converts a modulated digital signal into an analog signal and sends the converted analog signal through an antenna.

A problem occurs when a channel's root mean square (RMS) delay spread is likely to have a value less than about 100 nS, which indicates a standard deviation or the root mean square of a delay of reflection waves, since room environments in which the wireless LAN is primarily placed provide narrow frequency bands compared to outdoor environments. In the wireless LAN system using a band of about 20 MHz, the channels have flat-fading frequency characteristics regardless of frequencies due to the RMS delay spread, and all sub-carriers are affected by the similar fading.

Such fading environments degrade a signal-receiving function due to no effect of the diversity of the channel encoding, and such a problem occurs in the same way as in the MIMO transmission system using plural antennas.

### SUMMARY OF THE INVENTION

In order to solve the foregoing and/or other problems, the present general inventive concept provides a MIMO OFDM-based wireless LAN system and method to enhance an effect of diversity of transmission systems thereof under flat fading environments.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a MIMO transmission system of an OFDM-based wireless LAN system, the MIMO transmission comprising a de-multiplexer to split an input bit stream into at least one bit stream to distribute the input bit stream to at least one path, at least one channel encoder to encode the bit stream outputted from the de-multiplexer, at least one puncturer to control an encoding rate of the channel encoder, a spatial bit exchanger to switch bits of the bit stream to arrange the bits of the bit stream output from the puncturer to the path, at least one interleaver to distribute errors that can occur in a transmission channel with respect to the switched bit stream outputted from the spatial bit exchanger, at least one symbol mapper to modulate the bit stream outputted from the interleaver for subcarriers, at least one IFFT/GI insertion unit to apply an inverse fast Fourier transform to the bit stream modulated by the symbol mapper, and inserting a guard interval, at least one DAC/RF unit to convert a digital signal of the IFFT/GI insertion unit into an analog signal for wireless transmissions, and at least one antenna for at least one channel which is connected to the DAC/RF unit.

The spatial bit exchanger may includes a switching unit to switch to different paths individual bits of the bit stream from the puncturer, and a routing control unit to control sequential switching operations of the switching unit according to a pre-set algorithm in order for the bit stream of one path to be sequentially sent to the different paths.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing a transmission system of an OFDM-based wireless LAN system according to an embodiment of the present general inventive concept;

FIG. 2 is a block diagram showing a spatial bit exchanger of the transmission system of FIG. 1;

FIG. 3 is a view showing operations of the spatial bit exchanger of FIG. 2 according to an embodiment of the present general inventive concept; and

FIG. 4 is a view showing bit stream exchanges of the spatial bit exchanger of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

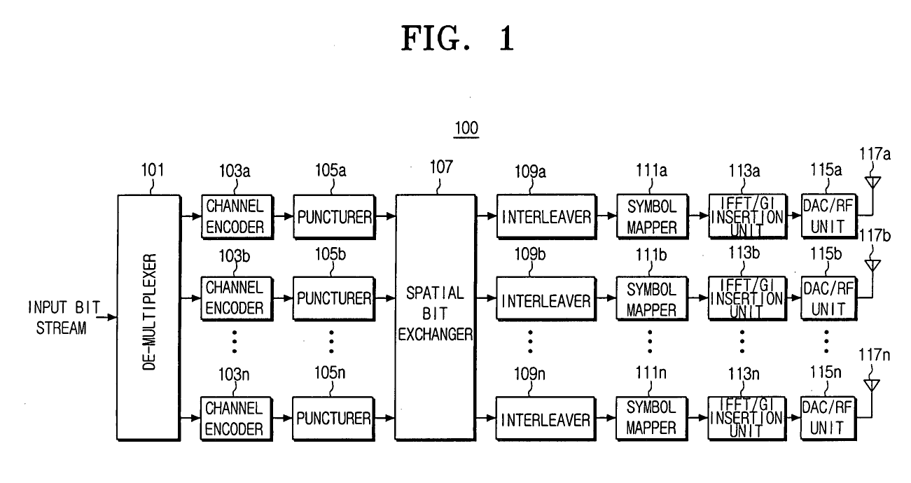

FIG. 1 is a block diagram showing a transmission system 100 for an OFDM-based wireless LAN system according to an embodiment of the present general inventive concept.

In FIG. 1, the transmission system 100 includes a de-multiplexer 101, channel encoders 103a to 103n, puncturers 105a to 105n, a spatial bit exchanger 107, interleavers 109a to 109n, symbol mappers 111a to 111n, IFFT/GI insertion units 113a to 113n, DAC/RF units 115a to 115n, and antennas 117a to 117n.

The individual components of the transmission system 100 carry out a process of channel encoding and modulations for wireless transmission of input bit streams. The transmission system 100 can be a multiple-input/multiple-output (MIMO) transmission system having multiple transmission paths through multiple antennas 117a to 117n.

The input bit stream inputted to the MIMO transmission system 100 are split into plural bit streams through the de-multiplexer 101, and each of the split bit streams is encoded, OFDM-modulated, and transmitted through a corresponding one of the multiple transmission paths, wherein the OFDM stands for ‘Orthogonal Frequency Division Multiplexing.’ The split bit stream may be a unit bit stream to be transmitted through a corresponding channel to a corresponding one of the antennas 117a to 117n.

Further, when the unit bit streams split in the de-multiplexer 101 are transmitted to the same transmission antenna, all bits of the unit bit streams are affected by the same fading due to flat-fading environments, so the spatial bit exchanger 107 is used to sequentially exchange the antennas 117a to 117n to transmit the bits of the unit bit streams through the sequentially exchanged antennas 117a to 117n. Thus, the bits are transmitted to different transmission antennas 117a to 117n, and their fading characteristics become different, so that diversity gains can be obtained.

The de-multiplexer 101 splits an inputted single bit stream into plural bit streams to be distributed through multiple paths to the individual antennas 117a to 117n.

The channel encoders 103a to 103n each implement channel encoding using a convolutional code or the like.

The puncturers 105a to 105n control an encoding rate of the channel encoders 103a to 103n. The puncturers 105a to 105n delete predetermined selected bits to reduce coding overhead of the channel encoders 103a to 103n.

The interleavers 109a to 109n distribute for error corrections a localized error burst that may occur in transmission channels.

The symbol mappers 111 a to 111n apply BPSK modulation, QPSK modulation, QAM modulation, or the like to the unit bit streams to be transmitted to the respective OFDM subcarriers.

The IFFT/GI insertion units 113a to 113n implement the OFDM modulation by applying the inverse fast Fourier transform (IFFT) to digital signals modulated by the symbol mappers 111a to 111n to transform the digital signals into time-domain data, and insert a guard interval (GI) into each frame of the time-domain data to minimize an inter-symbol interference.

The DAC/RF (digital-analog converter/radio frequency) units 115a to 115n convert the OFDM-modulated digital signals into analog signals such that the analog signals are transmitted through the antennas 117a to 117n for the individual channels. The analog signals may be an RF signal.

The spatial bit exchanger 107 exchanges transmission paths before inputting to the interleavers 109a to 109n the unit bit streams passing through the channel encoders 103a to 103n and puncturers 105a to 105n in the corresponding signal processing paths of the respective transmission antennas 117a to 117n.

The spatial bit exchanger 107 exchanges the input bits among the antennas 117a to 117n in the spatial dimension so that one input bit stream is not transmitted to a single antenna but to the plural antennas 117a to 117n.

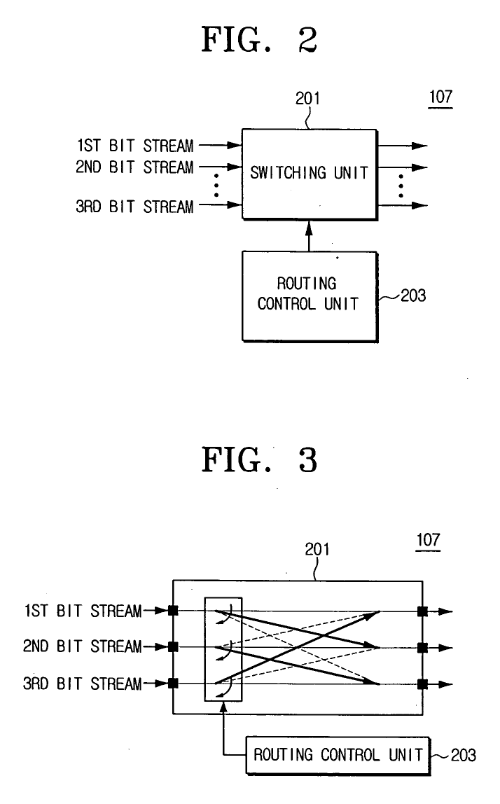

FIG. 2 is a block diagram showing the spatial bit exchanger 107 of FIG. 1.

In FIG. 2, the spatial bit exchanger 107 includes a switching unit 201 and a routing control unit 203.

The routing control unit 203 receives n rows of bit streams from n puncturers 105a to 105n, and controls the switching unit 201 to route the bit streams to different paths. The routing control unit 203 routes to different paths the bits received from individual paths at each point of time according a pre-set algorithm, e.g., switching algorithm.

The switching algorithm of the routing control unit 203 includes a variety of methods of distributing and outputting to plural paths the bits of the bit streams input through a path.

The switching unit 201 switches to the different paths the bit streams of the individual paths inputted according to controls of the routing control unit 203.

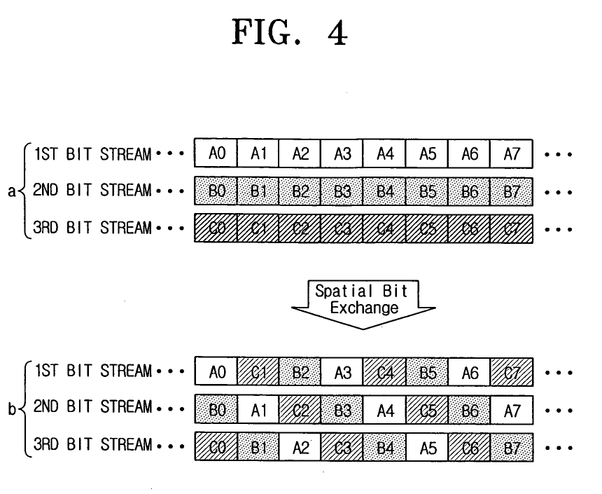

FIG. 3 is a view explaining operations of the spatial bit exchanger 107 of FIG. 2.

The spatial bit exchanger 107 shown in FIG. 3 is based on the MIMO transmission system 100 having three paths connected to three antennas, for example. The spatial bit exchanger 107 inputs three rows of bit streams, e.g., first, second, and third streams, to the switching unit 201.

The routing control unit 203 controls the bits of the first stream to be transmitted to the path for the second antenna 117b, the bits of the second bit stream to the path for the third antenna 117c, and the bits of the third bit stream to the path for the first antenna 117a, and controls the bits thereafter to be transmitted to a different path in another different method.

FIG. 4 is a view explaining the bit stream exchange of the spatial bit exchanger 107 of FIGS. 1 and 3. Referring FIGS. 3 and 4, a reference numeral “a” indicates three rows of bit streams inputted to the spatial bit exchanger 107, and a reference numeral “b” indicates bit streams output through the spatial bit exchanger 107.

The spatial bit exchanger 107 switches the bits of input bit streams in order for the bits of the respective input bit streams to be arranged and sent to the three antennas 117a, 117b, and 117c. That is, the bits of the first bit streams A0, A1, and A2 are respectively transmitted to the first antenna 117a, the second antenna 117b, and the third antenna 117c, and the bits thereafter are arranged and sent to the antennas 117a, 117b, and 117c in the same method.

Accordingly, since the bits of one bit stream are transmitted to the different antennas 117a to 117n, the fading characteristics become different so that diversity gains can be obtained.

The transmission system can carry out a MIMO transmission mode for the OFDM-based wireless LAN system.

As described above, the MIMO OFDM-based wireless LAN system according to the present general inventive concept can enhance the diversity gains by the channel encoding in the flat-fading environments having a small RMS delay spread through the bit exchanges among the transmission antennas.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A MIMO transmission system of an OFDM-based wireless LAN system, comprising:
a de-multiplexer to split an input bit stream into at least one bit stream to distribute the input bit stream to one or more paths;
at least one channel encoder to encode the bit stream output from the de-multiplexer;
at least one puncturer to control an encoding rate of the channel encoder;
a spatial bit exchanger to switch bits of the bit stream output from the puncturer to arrange the bits of the bit stream to the path;
at least one interleaver to distribute errors that occur in a transmission channel with respect to the switched bit stream output from the spatial bit exchanger;
at least one symbol mapper to modulate the bit stream output from the interleaver according to a corresponding subcarrier;
at least one IFFT/GI insertion unit to apply an inverse fast Fourier transform to the bit stream modulated by the symbol mapper, and to insert a guard interval into the bit stream;
at least one DAC/RF unit to convert an output of the IFFT/GI insertion unit into an analog signal; and
at least one antenna connected to the DAC/RF unit to wirelessly transmit the analog signal.

2. The MIMO transmission system as claimed in claim 1, wherein the spatial bit exchanger comprises:
a switching unit to switch individual bits of the unit bit stream from the puncturer to different paths of the one or more paths; and
a routing control unit to control sequential switching operations of the switching unit according to a pre-set algorithm in order for the unit bit stream to be sequentially sent to the different paths of the one or more paths.

3. A MIMO transmission system of an OFDM-based wireless LAN system, comprising:
a de-multiplexer to receive an input bit stream and to split the received input bit stream into a plurality of stream groups each having one or more bit streams;
one or more channel encoders to encode corresponding ones of the bit streams of each of the plurality of stream groups output from the de-multiplexer;
one or more puncturers to control an encoding rate of the one or more channel encoders when the corresponding ones of the bit streams of the each of the plurality of stream groups are encoded in the one or more channel encoders;
one or more transmission channels and antennas to wirelessly transmit corresponding ones of the encoded bit streams of the each of the plurality of stream groups; and
a spatial bit exchanger to receive the encoded bit streams of the each of the plurality of stream groups to assign the received bit streams of the each of the plurality of stream groups to different ones of the one or more transmission channels and antennas.

4. The MIMO transmission system as claimed in claim 3, wherein the spatial bit exchanger assigns the bit streams of the each of the plurality of stream groups to the one or more transmission channels and antennas in different order.

5. The MIMO transmission system as claimed in claim 3, wherein the spatial bit exchanger assigns the received bit streams of the adjacent stream groups to different ones of the one or more transmission channels and antennas

6. The MIMO transmission system as claimed in claim 3, wherein the bit streams of each of the plurality of stream groups are assigned to the one or more channel encoders in the same order, and the encoded bit streams of the each of the plurality of stream groups are assigned to the one or more transmission channels and antennas in different order.

7. The MIMO transmission system as claimed in claim 3, wherein the bit streams of each of the plurality of stream groups are assigned to the one or more channel encoders in a first order, and the encoded bit streams of the each of the plurality of stream groups are assigned to the one or more transmission channels and antennas in a second order.

8. The MIMO transmission system as claimed in claim 3, wherein the bit streams of each of the plurality of stream groups are assigned to the one or more channel encoders in a first order, and the encoded bit streams of the each of the plurality of stream groups are assigned to the one or more transmission channels and antennas in one of the first order and at least two second orders sequentially.

9. The MIMO transmission system as claimed in claim 3, wherein the bit streams of each of the plurality of stream groups are assigned to the one or more channel encoders in a first order, and the encoded bit streams of the each of the plurality of stream groups are assigned to the one or more transmission channels and antennas in different ones of a plurality of second orders.

10. The MIMO transmission system as claimed in claim 9, wherein one of the plurality of second orders is the same as the first order.

11. The MIMO transmission system as claimed in claim 3, wherein the transmission channels have localized error bursts, and the spatial bit exchanger distributes error corrections to the assigned bit streams of the each of the plurality of stream groups to compensate for corresponding ones of the localized error bursts of the transmission channels, applies a modulation method to the assigned bit streams of the each of the plurality of stream groups, and transform each of the bit streams of the each of the plurality of stream groups into time-domain data, insert a guard interval into the time-domain data to minimize an inter-symbol interference, and converts the time-domain data into an analog signal to be wirelessly transmitted through corresponding ones of the antennas.

12. The MIMO transmission system as claimed in claim 3, wherein each of the one or more transmission channels and antennas comprises:
an interleaver to distribute error corrections to the bit streams of the each of the plurality of stream groups to compensate for localized error bursts of the transmission channels;
a symbol mapper to apply a modulation method to the bit streams of the each of the plurality of stream groups;
an IFFT/GI insertion unit to transform each of the modulated bit streams of the each of the plurality of stream groups into time-domain data, and to insert a guard interval into the time-domain data to minimize an inter-symbol interference;
a DAC/RF unit to convert the time-domain data into an analog signal; and
an antenna to wirelessly transmit the analog signal.

13. The MIMO transmission system as claimed in claim 3, wherein the split bit streams comprise a unit bit stream.

14. The MIMO transmission system as claimed in claim 13, wherein the unit bit stream varies.

15. The MIMO transmission system as claimed in claim 3, wherein:
each of the plurality of stream groups comprises first, second, and third bit streams;
the one or more transmission channels and antennas comprise first, second, and third transmission channels and antennas; and
the spatial bit exchanger assigns the first, second, and third bit streams of the each of the plurality of stream groups to first, second, and third transmission channels and antennas in different order.

16. The MIMO transmission system as claimed in claim 3, wherein:
the plurality of stream groups comprises first, second, and third stream groups each having first, second, and third bit streams;
the one or more transmission channels and antennas comprise first, second, and third transmission channels and antennas; and
the spatial bit exchanger assigns the first, second, and third bit streams of the first stream group to the first, second, and third transmission channels and antennas in a first order, assigns the first, second, and third bit streams of the second stream group to the first, second, and third transmission channels and antennas in a second order, and assigns the first, second, and third bit streams of the third stream group to the first, second, and third transmission channels and antennas in a third order.

17. The MIMO transmission system as claimed in claim 3, wherein:
the plurality of stream groups comprises first, second, and third stream groups each having first, second, and third bit streams;
the one or more transmission channels and antennas comprise first, second, and third transmission channels and antennas; and
the spatial bit exchanger assigns the first, second, and third bit streams of the first stream group to the first, second, and third transmission channels and antennas, respectively, assigns the first, second, and third bit streams of the second stream group to third, first, and second transmission channels and antennas, respectively, and assigns the first, second, and third bit streams of the third stream group to the second, third, and first transmission channels and antennas, respectively.

18. The MIMO transmission system as claimed in claim 3, wherein:
each of the plurality of stream groups comprises first, second, and third bit streams;
the one or more transmission channels and antennas comprise first, second, and third transmission channels and antennas having first, second, and third errors; and
the spatial bit exchanger assigns the first, second, and third bit streams of the each of the plurality of stream groups to first, second, and third transmission channels and antennas in different order, and distributes first, second, and third error bursts to the assigned first and second, and third bit streams to compensate for the first, second, and third errors, respectively.

19. The MIMO transmission system as claimed in claim 3, wherein the spatial bit exchanger comprises:
a switching unit to switch the one or more transmission channels and antennas to assign the bit streams of the each of the stream groups to corresponding ones of the one or more transmission channels and antennas; and
a routing control unit to control sequential switching operations of the switching unit according to a pre-set algorithm in order for the unit bit stream to be sequentially sent to the corresponding ones of the one or more transmission channels and antennas in different order.

20. An OFDM-based wireless LAN system using a MIMO transmission system, comprising:
a de-multiplexer to receive an input bit stream and to split the received input bit stream into a plurality of stream groups each having one or more bit streams;
one or more channel encoders to encode corresponding ones of the bit streams of each of the plurality of stream groups output from the de-multiplexer;
one or more puncturers to control an encoding rate of the one or more channel encoders when the corresponding ones of the bit streams of the each of the plurality of stream groups are encoded in the one or more channel encoders;
one or more transmission channels and antennas to wirelessly transmit corresponding ones of the encoded bit streams of the each of the plurality of stream groups; and
a spatial bit exchanger to receive the encoded bit streams of the each of the plurality of stream groups to assign the received bit streams of the each of the plurality of stream groups to different ones of the one or more transmission channels and antennas.
